(19) United States
(12) Patent Application Publication
(10) Pub. No.: US 2016/0180031 A1
(43) Pub. Date: Jun. 23, 2016

(54) SYSTEM AND METHOD FOR MANAGING AND REPORTING INVENTORIES OF PHARMACEUTICAL SAMPLES

(71) Applicant: David A. Slater, Irving, TX (US)

(72) Inventor: David A. Slater, Irving, TX (US)

(21) Appl. No.: 14/973,050

(22) Filed: Dec. 17, 2015

Related U.S. Application Data
(60) Provisional application No. 62/093,873, filed on Dec. 18, 2014.

(51) Int. Cl. G06F 19/00; H04L 29/06; G06F 17/30; G06Q 10/08; G06Q 50/22

(52) U.S. Cl. CPC G06F 19/327; G06Q 10/087; G06Q 50/22; G06F 17/30368; G06F 17/30864; H04L 63/102

(57) ABSTRACT

A system and method of managing pharmaceutical samples at a health care professional facility are provided. In one embodiment, the system includes a server, including a database configured to store information about at least one pharmaceutical sample stored at the facility. The server is configured to facilitate a remote access to the information in the database by an authorized user of the system using a user equipment and to periodically process the information.

### CROSS-REFERENCE TO RELATED APPLICATION

This application claims priority to U.S. Provisional Application Ser. No. 62/093,873, filed on Dec. 18, 2014, entitled “Tracker Embodiment Description,” which is incorporated herein by reference.

### TECHNICAL FIELD

This application is directed, in general, to inventory management and reporting systems and, more specifically, to a system and method for managing pharmaceutical samples that are typically stored in a health care professional (HCP) facility.

### BACKGROUND

Distribution of pharmaceutical samples by pharmaceutical manufacturers is highly regulated. The manufacturers are required to distribute samples only in response to a formal written request from an HCP licensed in their respective states and to maintain records of the distributions. Once the pharmaceutical samples reach the HCP, the HCP becomes responsible for their management. Some HCPs have adopted rigorous internal procedures for logging the arrival and dispensing to patients of pharmaceutical samples.

### SUMMARY

One aspect provides a system for managing pharmaceutical samples at a health care professional facility. In one embodiment, the system includes a server comprising a database configured to store information about at least one pharmaceutical sample stored at the facility. The server is configured to facilitate a remote access to the information in the database by an authorized user of the system using a user equipment and to periodically process the information.

Another aspect provides a method of managing pharmaceutical samples stored in at least one heath care professional facility. In one embodiment, the method includes: (1) receiving a pharmaceutical sample identifier from an user equipment, (2) accessing information about a pharmaceutical sample corresponding to the identifier and (3) notifying a manufacturer of the pharmaceutical sample if the current quantity of the pharmaceutical sample is below a minimum quantity. The accessed information includes the current quantity of the pharmaceutical sample in the at least one health care professional facility.

In yet another aspect provides a method of managing a pharmaceutical sample inventory at a heath care professional facility. In one embodiment, the method includes: (1) periodically processing information about pharmaceutical samples stored in at least one health care professional facility, the information including expiration dates of the pharmaceutical samples, (2) determining whether at least one of the pharmaceutical samples has an expiration date that is within a threshold time period and (3) notifying a manufacturer of the at least one pharmaceutical sample if the expiration date is within the threshold time period.

### BRIEF DESCRIPTION

Reference is now made to the following descriptions taken in conjunction with the accompanying drawings, in which:

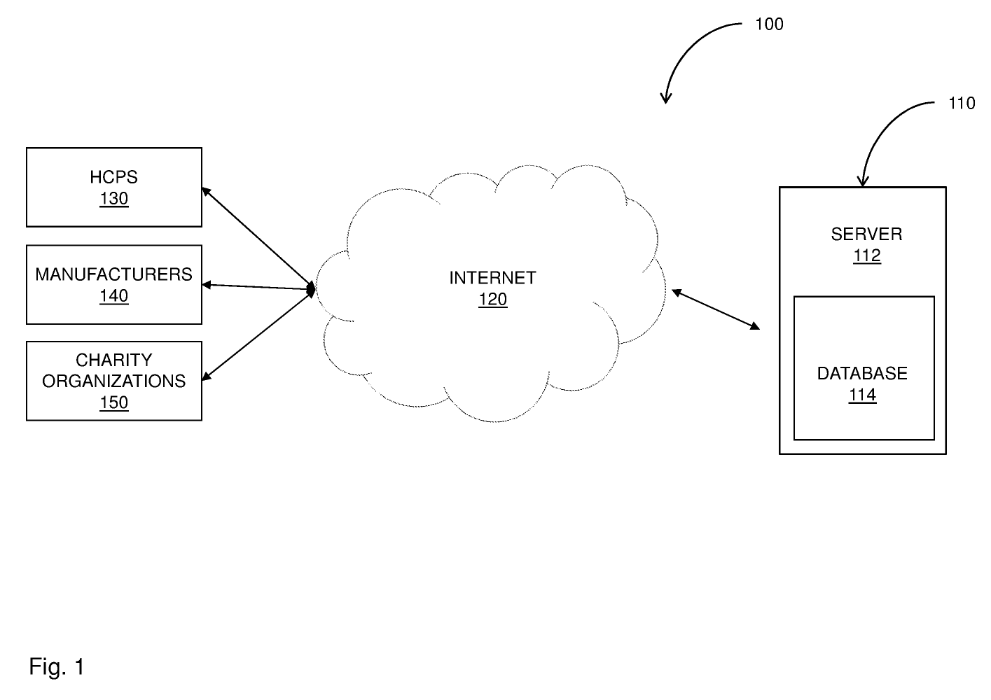

FIG. 1 is a block diagram of a network environment having one embodiment of a system for managing pharmaceutical samples at a health care professional facility;

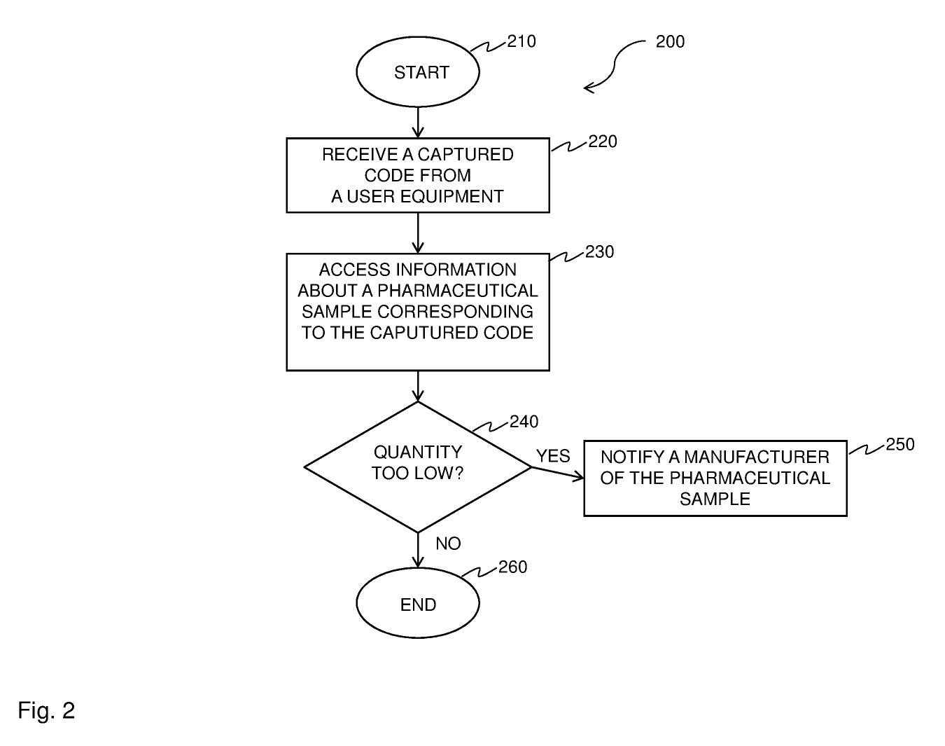

FIG. 2 is a flow diagram of one embodiment of a method for managing pharmaceutical samples at a heath care professional facility; and

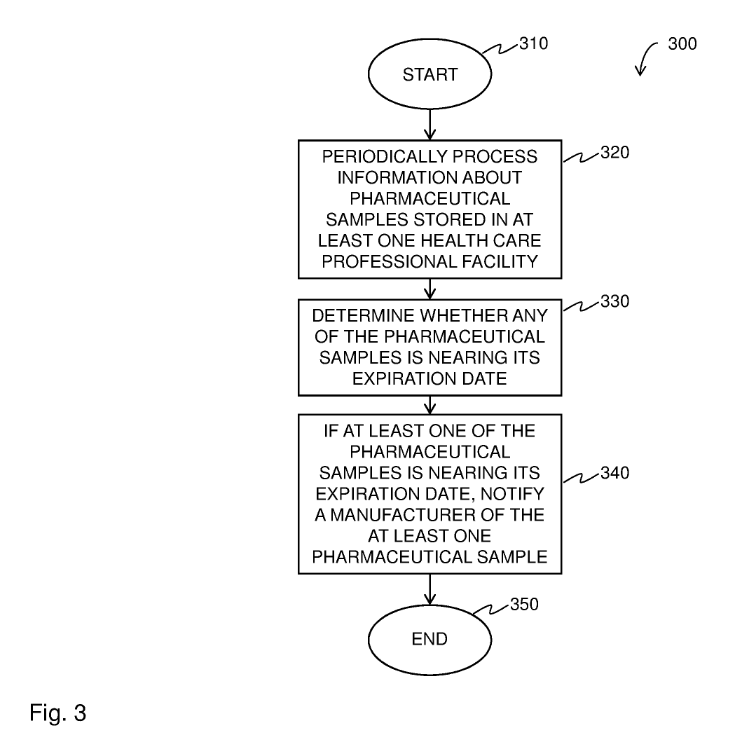

FIG. 3 is a flow diagram of another embodiment of a method for managing pharmaceutical samples at a health care professional facility.

### DETAILED DESCRIPTION

As stated above, pharmaceutical sample manufacturers are required to distribute samples only in response to a formal written request from a licensed HCP and to maintain records of the distribution. However, once the pharmaceutical samples reach the HCP, their storage and provision are virtually unregulated.

As stated above, some HCPs have adopted rigorous internal procedures for logging the arrival and dispensing to patients of pharmaceutical samples. Others, however, have not, and do not adequately manage their samples. In many instances, pharmaceutical samples are stored without periodic processing or inventory and provided without proper recording.

This lack of processing/inventory and documentation presents issues for both HCPs and pharmaceutical manufacturers. For example, as periodic processing/inventory of stored pharmaceutical samples is not carried out, expiration dates of the pharmaceutical samples are not monitored, and a lot of the samples are wasted. Also, as the expired pharmaceutical samples are not retrieved periodically, they are inadvertently provided to a patient. Moreover, as the pharmaceutical samples are provided without proper recording, when the prescribed samples are recalled, it becomes virtually impossible to track and retrieve the recalled samples and prevent the patient from using the recalled samples.

Introduced herein is a system and method for managing pharmaceutical samples stored in an HCP facility. In one embodiment, information about pharmaceutical samples in a HCP facility is stored in a database of a server. The information is remotely accessed over the internet by an authorized user using a user equipment. The server periodically processes the information about all the stored pharmaceutical samples to determine whether an attention of the authorized user is needed and notifies the appropriate authorized users automatically. For example, when certain pharmaceutical samples are determined to be nearing their expiration dates, they are identified and notified accordingly.

In addition to the periodic processing, the server also processes the information about a certain pharmaceutical sample when the information about that pharmaceutical sample is changed. For example, when a quantity or a recall status of a certain pharmaceutical sample is changed, the server processes the change and notifies the appropriate user if necessary.

FIG. 1 is a diagram of an exemplary network environment 100 where an embodiment of a system 110 for managing pharmaceutical samples stored at a HCP facility is used. HCPs 130, manufacturers of the stored pharmaceutical samples 140, and charity organizations 150 are some of the authorized users of the system 110. The system 110 and the authorized users 130, 140, 150 communicate with one another over the internet 120 using a user equipment.

In the illustrated embodiment, the system 110 includes a server 112 that includes a database 114. The database 114 is configured to store information about pharmaceutical samples stored in the HCPs 130's facilities. Some of the information includes: (1) expiration dates of the pharmaceutical samples, (2) manufacturers of the pharmaceutical samples, (3) names of patients who received the pharmaceutical samples, (4) authorization histories of the pharmaceutical samples including names of health care professionals who authorized provisions of the pharmaceutical samples and times of the provisions, (5) current quantities of the pharmaceutical samples and (6) alternatives/substitutes of the pharmaceutical samples.

Remote Access

In the illustrated embodiment, the server 112 is configured to facilitate a remote access to the stored information in the database 114 by the authorized users 130, 140, 150. The remote access is facilitated using an application that is executed on a user equipment (UE) of the authorized users 130, 140, 150. The UE includes a smart phone, tablet, personal computers and other devices that are capable of communicating with the server 112 and other authorized users 130, 140, 150 over the internet 120.

In the illustrated embodiment, each authorized user 130, 140, 150 is provided with a user name and a password to log into the server 112 and access the information stored in the database 114. Once logged in, the authorized users 130, 140, 150 may retrieve information about a pharmaceutical sample using a pharmaceutical sample identifier of the pharmaceutical sample. The pharmaceutical sample identifier includes a serial number, a lot number, and/or a picture of a pharmaceutical sample. In one embodiment, a pharmaceutical sample identifier is captured using an optical scanner, e.g., a barcode or image scanner or a camera of the UE. In another embodiment, a pharmaceutical sample identifier may be entered manually by the authorized user 130, 140, 150.

Once information about a certain pharmaceutical sample is retrieved, the authorized user 130, 140, 150 may update the information. For example, the authorized users 130, 140, 150 may update a current quantity of a certain pharmaceutical sample and/or indicate that a certain pharmaceutical sample has been recalled. In one embodiment, the authorized users 130, 140, 150 may also set certain thresholds for processing the information as described further below.

In one instance, information about a certain pharmaceutical sample may not be available in the database 114. In such instance, an appropriate authorized user, e.g., HCPs 130 or manufacturer 140, may create an entry for a new pharmaceutical sample using a pharmaceutical sample identifier of the new pharmaceutical sample. The information about the new pharmaceutical sample may be populated automatically upon capturing the pharmaceutical identifier, e.g., a serial number, a lot number, and a picture of the new pharmaceutical sample. In one embodiment, the information about the new pharmaceutical sample may be entered manually.

In one embodiment, the database 114 may store information about pharmaceutical samples stored in a single HCP facility. In another embodiment, the database 114 may store information about pharmaceutical samples stored in multiple HCP facilities. It is understood that each HCP facility may have one or more pharmaceutical sample cabinets/storages on site.

Security

In the illustrated embodiment, when one of the authorized user 130, 140, 150 logs onto the server 112, information that is pertinent only to that authorized user would be available. For example, when a HCP 130, e.g., a physician, logs onto the server 112, information about only those pharmaceutical samples that are stored in that HCP's facility, irrespective of their manufacturers, would be available, and when a pharmaceutical manufacturer 140, e.g., a sales representative, logs on to the server 112, information about only those pharmaceutical samples that the manufacturer has manufactured, irrespective of their storage locations, would be available. It is noted that information about patients who received pharmaceutical samples would only available to a HCP 130 as such information is protected by the US Health Insurance Portability and Accountability Act and similar state patient privacy laws.

Inventory

In the illustrated embodiment, the server 112 is configured to periodically process information, i.e. take an inventory, of pharmaceutical samples stored in the database 114. In one embodiment, the server 112 is configured to take an inventory daily. In another embodiment, the server 112 is configured to take an inventory weekly. In yet another embodiment, the server 112 is configured to take an inventory monthly. It is understood that the frequency of the inventory is not limited to those mentioned above and may be taken on-demand by the authorized users 130, 140, 150.

Based on the inventory, the server 112 is configured to determine which of the stored pharmaceutical samples are nearing their expiration dates. It is defined herein that a pharmaceutical sample is nearing its expiration date when an expiration date of the pharmaceutical samples is within a threshold time period. The threshold time period may be set by any of the authorized users 130, 140, 150, to be within as small as a week to as large as few months. In one embodiment, the threshold time period is set to be within two months.

When the server 112 determines that some of the pharmaceutical samples are nearing their expirations, the server 112 automatically sends a notification to the authorized users 130, 140, 150 about those expiring pharmaceutical samples. In one embodiment, the notification may be in the form of email, text, push alarm or facsimile. The term “automatically” is defined herein as not requiring any further action from the server 112. In one embodiment, the server 112 is configured to generate a report that lists the expiring pharmaceutical samples based on the inventory and send the report as a part of the notification.

In one embodiment, the notification is sent automatically to a pharmaceutical manufacturer that has manufactured at least one of the expiring pharmaceutical samples. This allows the pharmaceutical manufacturer to retrieve the expiring pharmaceutical samples for a termination and/or redistribution. In another embodiment, the notification automatically is sent to a HCP of a HCP facility in which at least one of the expiring pharmaceutical samples is stored. This allows the HCP 130 to be aware of the expiring pharmaceutical sample and act accordingly. In yet another embodiment, the notification is sent automatically to a charity organization that is in an immediate need of the expiring pharmaceutical sample. This allows the expiring pharmaceutical sample to be redistributed to the charity organization.

In the illustrated embodiment, the server 112 is also configured to determine an expected shelf time of at least one pharmaceutical sample based on the inventory. In one embodiment, the expected shelf time is determined based on a current quantity and a provision frequency of a pharmaceutical sample.

In one embodiment, when at least one of the pharmaceutical samples that the pharmaceutical manufacturer 140 has manufactured is determined to be nearing an end of its expected shelf time, a notification for expiring shelf time is sent automatically to the pharmaceutical manufacturer 140. This allows the pharmaceutical manufacturer 140 to restock the samples so that the HOPS 130 have enough samples at hand at all times. In one embodiment, the notification may be in the form of email, text, push alarm or facsimile.

Recall

In the illustrated embodiment, the server 112 is configured to automatically send a recall notification. In this embodiment, the pharmaceutical manufacturer 140 notifies the server 112 that a certain pharmaceutical sample has been recalled. As this information is updated in the database, the server 112 processes the information about that certain pharmaceutical sample and automatically sends a recall notification to patients who have received the recalled pharmaceutical samples. This is particularly beneficial for the pharmaceutical manufacturer in that the patient information is generally not available to them. In one embodiment, the notification may be in the form of email, text, push alarm or facsimile.

FIG. 2 is a flow diagram of one embodiment of a method 200 for managing pharmaceutical samples stored in at least one HCP facility. The method 200 is carried out by a server, e.g., the server 112 in FIG. 1, which includes a database, e.g., the database 114 in FIG. 1. The method 200 starts at a step 210.

In a step 220, a captured code, e.g., a pharmaceutical sample identifier, from an user equipment (UE) is received. In one embodiment, the captured code may be a serial number, a lot number, and/or a picture of a pharmaceutical sample that uniquely identifies one of the pharmaceutical samples stored in at least one HCP facility.

In a step 230, information about the identified pharmaceutical sample is accessed by the server. As discussed above, the information includes, among others, a current quantity of the identified pharmaceutical sample.

In a step 240, the current quantity of the identified pharmaceutical sample is compared to a threshold minimum quantity to determine whether the current quantity is too low. The threshold minimum quantity may be set by an authorized user such as the HCP 130 or manufacturer 140 in FIG. 1. The threshold minimum quantity may be set based on a number of samples that have been provided during a fixed time period. For example, if one hundred (100) pharmaceutical samples have been prescribed during a two (2) month period, the threshold minimum quantity may be set at fifty (50) samples so that the pharmaceutical samples can be restocked within a month.

If it is determined that the current quantity of the identified pharmaceutical samples is too low, i.e. below the threshold minimum quantity, the manufacturer of the identified pharmaceutical is notified of the shortage in a step 250. In one embodiment, the notification may be in the form of email, text, push alarm or facsimile. In one embodiment, the notification is sent to the manufacturer automatically upon determining that the current quantity of the identified pharmaceutical samples is too low.

In one embodiment, the current quantity of the identified pharmaceutical sample is also compared to a threshold maximum quantity to determine whether the current quantity is too high. Like the threshold minimum quantity, the maximum threshold quantity may be set by an authorized user such as the HCP 130 and/or the manufacturer 140 in FIG. 1. The threshold maximum quantity may be set based on a number of samples that have been provided during a fixed time period and the storage capacity of the HCP facility.

If it is determined that the current quantity of the identified pharmaceutical samples is too high, i.e. above the threshold minimum quantity, the manufacturer of the identified pharmaceutical sample is notified of the overage. In one embodiment, the notification is sent automatically to the manufacturer upon determining that the current quantity of the identified pharmaceutical samples is too high. The method ends in a step 260.

FIG. 3 is a flow diagram of one embodiment of a method 300 for managing pharmaceutical samples store in at least one HCP facility inventory. The method 300 is carried out by a server, e.g., the server 112 in FIG. 1, which includes a database, e.g., the database 114 in FIG. 1. The method 300 starts at a step 310.

In a step 320, information about pharmaceutical samples stored in at least one HCP facility is processed periodically. In one embodiment, the information is processed daily. In another embodiment, the information is processed weekly or monthly. The information includes, among others, expiration dates of the stored pharmaceutical samples.

In a step 330, it is determined whether any of the pharmaceutical samples stored in the HCP facility is nearing its expiration date. As defined above, a pharmaceutical sample is nearing its expiration date when an expiration date of the pharmaceutical samples is within a threshold time period. In the step 330, the expiration dates of the pharmaceutical samples are compared to a threshold time period. In one embodiment, a threshold time range is set as one (1) month by an authorized user, e.g., a pharmaceutical manufacturer. In another embodiment, the step 330 is performed automatically upon the completion of the step 320.

In a step 340, if at least one of the stored pharmaceutical samples is nearing its expiration date, a manufacturer of that pharmaceutical sample is automatically notified. In one embodiment, the notification includes an email, text, push alarm or facsimile.

In an optional step, the notification is also automatically sent to a HCP of a HCP facility that store the expiring pharmaceutical sample. The notified HCP then would be able to either stop providing the expiring pharmaceutical sample altogether or prescribe them with a specific instruction to consume the sample before its expiration date.

Once notified of the expiring pharmaceutical samples, the manufacturer may retrieve the samples from the HCP facility for recycling or termination. In one embodiment, if there is a charity organization that is in an immediate need of the expiring pharmaceutical samples, the manufacturer may redistribute the samples to them. It is understood that as the steps 320 and 330 may be carried out automatically, the above method may be carried out autonomously once the frequency of the inventory is set. The method end in a step 350.

While the methods disclosed herein have been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

The above-described system and methods or at least a portion thereof may be embodied in or performed by various, such as conventional, digital data processors or computers, wherein the computers are programmed or store executable programs of sequences of software instructions to perform one or more of the steps of the methods. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, e.g., 200 and 300, or functions of the apparatuses described herein, e.g., a receiver and a transmitter.

Certain embodiments of the invention further relate to computer storage products with a non-transitory computer-readable medium that have program code thereon for performing various computer-implemented operations that embody the systems or carry out the steps of the methods set forth herein. Non-transitory medium used herein refers to all computer-readable media except for transitory, propagating signals. Examples of non-transitory computer-readable medium include, but are not limited to: magnetic media such as hard disks, floppy disks, and magnetic tape; optical media such as CD-ROM disks; magneto-optical media such as floptical disks; and hardware devices that are specially configured to store and execute program code, such as ROM and RAM devices. Examples of program code include both machine code, such as produced by a compiler, and files containing higher level code that may be executed by the computer using an interpreter.

Those skilled in the art to which this application relates will appreciate that other and further additions, deletions, substitutions and modifications may be made to the described embodiments.

What is claimed is:

1. A system for managing pharmaceutical samples at a health care professional facility, comprising:
a server comprising a database configured to store information about at least one pharmaceutical sample stored at said facility, said server being configured to facilitate a remote access to said information in said database by an authorized user of said system using a user equipment and to periodically process said information.

2. The system of claim 1, wherein said information includes:
an expiration date of said at least one pharmaceutical sample;
a manufacturer of said at least one pharmaceutical sample;
a name of patient who received said at least one pharmaceutical sample;
an authorization history of said at least one pharmaceutical sample including name of health care professional who authorized a provision of said at least one pharmaceutical sample and a time of said provision;
a current quantity of said at least one pharmaceutical sample; and
an alternative/substitute of said at least one pharmaceutical sample.

3. The system of claim 1, wherein said server is configured to determine an expected shelf time of said at least one pharmaceutical sample based on a current quantity of said at least one pharmaceutical sample and a provision frequency of said at least one pharmaceutical sample.

4. The system as recited in claim 1, wherein said server is configured to send a notification to said authorized user when a current quantity of said at least one pharmaceutical sample is below a minimum quantity.

5. The system as recited in claim 3, wherein said server is configured to send a notification to said authorized user when said expected shelf time is less than a threshold shelf time.

6. The system as recited in claim 1, wherein said server is configured to send a notification automatically to a recipient of said at least one pharmaceutical upon learning that said least pharmaceutical has been recalled.

7. The system as recited in claim 1, wherein said remote access includes updating a current quantity of said at least one pharmaceutical sample.

8. The system as recited in claim 1, wherein said server is configured to send a notification to said authorized user when said expiration of said at least one pharmaceutical sample is within a threshold time range.

9. The system as recited in claim 1, wherein said remote access includes adding a new pharmaceutical sample and information of said new pharmaceutical sample to said database.

10. The system as recited in claim 1, wherein said notification includes a text, an email, a push notification, and a facsimile.

11. The system as recited in claim 1, wherein said server is configured to send a notification to said authorized user when a current quantity of said at least one pharmaceutical sample is above a maximum quantity.

12. The system of claim 1, wherein said authorized user includes:
a health care professional at said health care professional facility;
a manufacturer of said at least one pharmaceutical sample;
a distributor of said at least one pharmaceutical sample; and
a charity organization.

13. The system of claim 1, wherein information about a patient who received said at least one pharmaceutical sample is only available to a health care professional at said health care professional facility.

14. A method of managing pharmaceutical samples stored in at least one heath care professional facility, comprising:
receiving a pharmaceutical sample identifier from an user equipment;
accessing information about a pharmaceutical sample corresponding to said identifier, said information including a current quantity of said pharmaceutical sample in said at least one health care professional facility; and
notifying a manufacturer of said pharmaceutical sample if said current quantity is below a minimum quantity.

15. The method of claim 14, wherein said pharmaceutical sample identifier includes at least one of:
a serial number of said at least one pharmaceutical sample;
a lot number of said at least one pharmaceutical sample; and
a picture of said at least one pharmaceutical sample.

16. The method of claim 14, further comprising notifying said manufacturer of said pharmaceutical sample if said current quantity is over a maximum quantity.

17. The method of claim 14, further comprising updating said current quantity of said pharmaceutical sample.

18. A method of managing pharmaceutical samples at a heath care professional facility, comprising:
periodically processing information about pharmaceutical samples stored in at least one health care professional facility, said information including expiration dates of said pharmaceutical samples;
determining whether at least one of said pharmaceutical samples has an expiration date that is within a threshold time period; and
notifying a manufacturer of said at least one pharmaceutical sample if said expiration date is within said threshold time period.

19. The method as recited in claim 18, further comprising notifying a charity organization that is in an immediate need of said at least one pharmaceutical sample.

20. The method as recited in claim 18, wherein said notifying said manufacturer includes generating and sending a report that indicates that said at least one pharmaceutical samples is nearing its expiration date.
